(19) United States
(12) Patent Application Publication
(10) Pub. No.: US 2009/0083364 A1
(43) Pub. Date: Mar. 26, 2009

(54) DATA COMMUNICATION SYSTEM, TERMINAL, CATALOG SERVER, DATA COMMUNICATION METHOD, AND COMMUNICATION PROGRAM PRODUCT

(75) Inventor: Tsutomu KITAMURA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/212,332

(22) Filed: Sep. 17, 2008

(30) Foreign Application Priority Data
Sep. 20, 2007 (JP) 2007-244033

(51) Int. Cl. G06F 15/16

(52) U.S. Cl. 709/201

(57) ABSTRACT

In order to provide a data communication system that reduces a data amount of messages, a simple catalog identifier 31 is assigned to a plurality of common parameters. Each of terminals or servers replaces the common parameters by the simple and identical catalog identifier and transmits the simple catalog identifier to other terminals or servers.

This application is based upon and claims the benefit of priority from Japanese patent application No. 2007-244033, filed on Sep. 20, 2007, the disclosure of which is incorporated herein in its entirety by reference.

### BACKGROUND OF THE INVENTION

1. Field of the Invention

The present invention relates to a data communication system that uses a network, and more particularly to a method for reducing the data amount of messages exchanged between terminals at the start of communications.

2. Related Background Art

One of major research themes in ubiquitous technology is a so-called sensor network. The sensor network is specified such that a wireless network is formed by plural terminals (hereinafter referred to as sensor terminals) which include sensors (e.g., temperature, humidity, vibration, acceleration, position, voice sensors, etc.) to comprehensively grasp or judge situations in a specific range from information obtained from the sensors. A wide variety of applications have been expected in connection with such a sensor network.

The sensor terminals include very simple computer resources (hereinafter referred to as resources) such as processor, memory, wireless module along with sensors to enable participation in a wireless network. Since an enormous number of sensor terminals must be installed and networked to realize a sensor network, the costs of the sensor terminals occupy a large percentage to total costs in building of transaction and life supporting systems. Therefore, to reduce costs, resources mounted in each of the sensor terminals should be as small as possible.

In order to perform data communication among the sensor terminals, signaling must be carried out between the sensor terminals or between each sensor terminal and a host computer or the like. In addition, communication parameters must be exchanged which are required in specific communication protocols. However, existing communication protocols, such as SIP (Session Initiation Protocol), have been mainly directed to advanced terminals with rich resources, such as a personal computer and a workstation.

Therefore, conventional sensor terminals must provide secure resources necessary for performing communication by existing communication protocols. Therefore, there have been limitations so as to reduce an amount of resources and to decrease costs. Herein, it is to be noted that such a decrease of costs of the sensor terminals requires a reduction of data amounts and processing amount in signaling to enable processing even in small terminals with reduced resources.

On the other hand, technologies for reducing the data amount of messages exchanged by terminals in signaling are disclosed in Non-patent Documents 1 and 2, and Patent Documents 1 and 2.

In Non-patent document 1, description is made about the algorithm of ROHC (Robust Header Compression) which serves to compress a header of a message. In the ROHC algorithm, data within a message is divided into a portion (static portion) that does not usually change, a portion (dynamic portion) that changes, and a regularly changing portion in the dynamic portion. The regularly changing portion might, for example, increase sequentially according to preceding and following messages. A transmission message has, as data, difference information between a preceding message and a current message. Next, a receiving side refers to the received message and the preceding message to perform message decompression processing. Thus, a header size is basically compressed in accordance with the above-mentioned manner and, as a result, the data amount of the message is reduced.

In non-patent document 2, description is made about a SigComp (Signaling Compression) algorithm that compresses an entire message which includes a header and a payload generated by a text-based signaling protocol such as SIP (Session Initiation Protocol). The SigComp algorithm compresses a protocol of text format to a binary format by a transmitting side. Next, the receiving side restores the compressed message of the binary format to the text format. By compressing message size in this way, the data amount of the message is reduced.

In Patent Document 1, description is made about a method of reducing the amount of data transmitted from sensor terminals in a sensor network to a transaction or processing server. When the sensor terminals transmit plural units of numeric data, basic data is extracted from the plural units of the numeric data. Next, difference values between the extracted basic data and each of the respective units of the numeric data are calculated. The calculated difference values are transmitted to the transaction server. Thereby, the amount of data received by the transaction server is reduced.

In Patent Document 2, description is made about a method for reducing the amount of message data by reducing an occupation rate of a head area relative to the entire traffic. When plural units of data can be gathered, a transmitting side transmits a header common to the plural units of data. With this method, the number of adding or transmitting the headers can be reduced and, therefore, an overhead size can also be reduced in the traffic.
Non-patent Document 1: Lars-Erik Jonsson, “RFC 4163: RObust Header Compression (ROHC): Requirements on TCP/IP Header Compression”, [online], August 2005, IETF, [Retrieval on Sep. 11, 2007], Internet <URL:http://www.ietf.org/rfc/rfc4163.txt>
Non-patent Document 2: M. Garcia-Martin et al., “RFC 3485: The Session Initiation Protocol (SIP) and Session Description Protocol (SDP) Static Dictionary for Signaling Compression (SigComp)”, [online], February 2003, IETF, [Retrieval on Sep. 11, 2007], Internet <URL:http://www.ietf.org/rfc/rfc3485.txt>
Patent Document 1: JP-A-2004-032176
Patent Document 2: JP-A-1999-187068

### SUMMARY OF THE INVENTION

Each of the methods shown in Non-patent Documents 1 and 2, and Patent Documents 1 and 2 realizes a reduction of data amount of a message exchanged during signaling by the terminals, by compressing message data. However, each terminal should carry out not only usual signaling processing but also compression and decompression of each message. Thus, throughput in each terminal is rather increased, which makes it difficult to decrease resources in each terminal, even if the above-mentioned technologies are applied to the sensor terminals.

Accordingly, the present invention seeks to solve one or more of the above problems related to a data communication system, a terminal, a server, a method, and a communication program product. At any rate, the present invention serves to reduce the data amount of messages without any substantial increase of throughput in each terminal.

A data communication system according to the present invention is a data communication system in which plural terminals communicate with each other through a network, wherein the terminals include: a first transmitting/receiving unit that communicates with other terminals through a network; a first catalog storage unit that stores common parameters associated with catalog identifiers; and a first message generating unit that replaces a common parameter included in communication data by a catalog identifier for transmission to other terminals.

A terminal according to the present invention is a terminal that communicate mutually with other terminals through a network, wherein the terminal includes: a transmitting/receiving unit that communicates with other terminals through the network; a catalog storage unit that stores common parameters associated with catalog identifiers; and a message generating unit that replaces a common parameter included in communication data by a catalog identifier for transmission to other terminals.

A catalog server according to the present invention is a catalog server is a catalog server in a data communication system in which plural terminal and one or plural catalog servers communicate with each other through a network, wherein the catalog server includes: a transmitting/receiving unit that communicates with other terminals through the network, and receives a common parameter list, which is a list of communication parameters handled as common parameters by the terminals; a message processing unit that issues a catalog identifier for a common parameter list; and a catalog storage unit that stores common parameters described in a common parameter list in association with catalog identifiers; and a message generating unit that replies a catalog identifier to a terminal.

A data communication method according to the present invention is a method for performing data communications in a data communication system in which plural terminals including a first catalog storage unit communicate each other through a network, wherein the method includes: a data generating step in which the terminals generate communication data transmitted to other terminals; a catalog retrieval step in which the terminals retrieve a common parameter associated with a catalog identifier from the first catalog storage unit; a first replacement step in which the terminals replace a common parameter included in communication data by a catalog identifier; and a transmitting step in which the terminals replaced communication data to other terminals.

A communication program product according to the present invention instructs a computer included in a terminal including the first catalog storage unit that can communicate with other terminals through a network to execute the functions of: generating communication data transmitted to other terminals; retrieving a common parameter associated with a catalog identifier from the catalog storage unit; replacing a common parameter included in communication data by a catalog identifier; and transmitting the replaced communication to other terminals.

A communication program according to the present invention instructs a computer included in a catalog server including a second catalog storage unit that can communicate with plural terminals and one or plural catalog servers through a network to execute the functions of: receiving a common parameter list from the terminals; issuing a catalog identifier for the common parameter list; storing common parameters described in the common parameter list in the second catalog storage unit in association with catalog identifiers; and replying catalog identifiers to the terminals.

The present invention is constructed to replace common parameters included in communication by a pertinent one of catalog identifiers for transmission to other terminals, as mentioned above. Herein, a plurality of the common parameters might be, for example, header information and are assigned with an identical and simple one of the catalog identifiers that is represented by a small amount of information as compared with the common parameters. Therefore, the amount of data can be reduced by simple replacement processing. This enables to reduce the data amount of messages without increasing the throughput in each of terminals and to structure an excellent data communication system, terminal, catalog server, data communication method, and communication program (or computer program product).

### BRIEF DESCRIPTION OF THE DRAWINGS

FIG. 1 is a conceptual diagram showing a network configuration of a data communication system according to an embodiment of the present invention;

FIG. 2 is a block diagram showing the configuration of a terminal disclosed in FIG. 1;

FIG. 3 is a block diagram showing the configuration of a catalog server disclosed in FIG. 1;

FIG. 4 is a conceptual diagram showing the structure of data stored in a common parameter list storage unit within the terminal and the catalog server disclosed in FIGS. 2 and 3

FIG. 5 is a conceptual diagram showing the structure of data stored in a catalog storage unit within the terminal and the catalog server disclosed in FIGS. 2 and 3;

FIG. 6 is a sequence diagram showing a communication procedure of the data communication system disclosed in FIG. 1

FIG. 7 is a flowchart showing the content of processing in the terminal disclosed in FIG. 2;

FIG. 8 is a flowchart showing the content of processing in the catalog server disclosed in FIG. 3;

FIG. 9 is a sequence diagram showing an example of performing the communication procedure of FIG. 6 in accordance with a concrete protocol;

FIG. 10 is an example of operations which carry out a catalog registration request transmitted to a catalog server by a terminal in FIG. 9 and a response responsive to the catalog registration request and returned from the catalog server to the terminal;

FIG. 11 is an example of a session establishment request and a session establishment request response transmitted to another terminal by a terminal in FIG. 9;

FIG. 12 is a catalog query request transmitted to a catalog server by a terminal in FIG. 9 and an example of a catalog query request response transmitted to the terminal by the catalog server; and

FIG. 13 is an example of a conventional INVITE message issued by a terminal in a conventional communication system.

### DESCRIPTION OF THE EXEMPLARY EMBODIMENTS

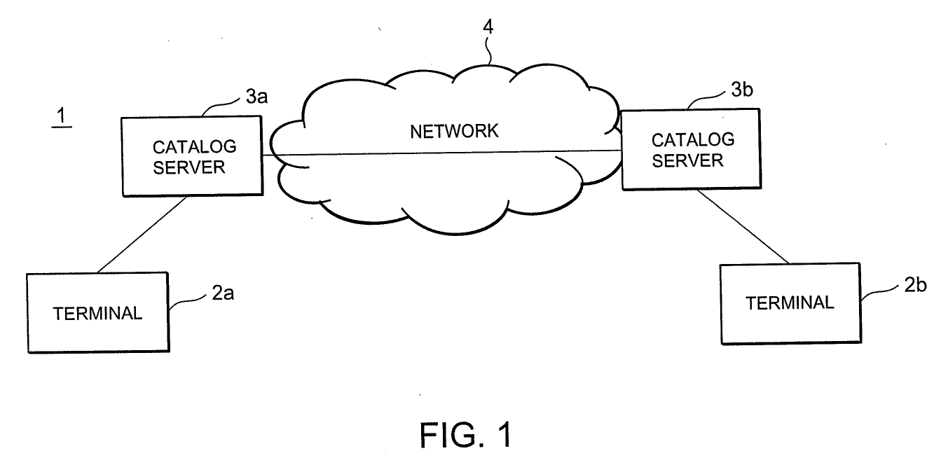

FIG. 1 is a conceptual diagram showing a network configuration of a data communication system 1 according to an embodiment of the present invention. In the data communication system 1, a terminal 2a and a catalog server 3a, and a terminal 2b and a catalog server 3b are connected respectively, and the catalog server 3a and the catalog server 3b are connected through a network 4. Since the terminal 2a and the terminal 2b have an identical construction in the illustrated example, these are collectively referred to as a terminal 2. Likewise, since the catalog server 3a and the catalog server 3b also have an identical construction, these are collectively referred to as a catalog server 3. Herein, it is noted in the instant specification that the term “catalog” is concerned with a list of common parameters, as will become clear as the description proceeds.

FIG. 1 shows the two terminals 2 and the two catalog servers 3 only in order to make it easy to understand the concept of the present invention. The terminals 2 and the catalog servers 3 need not be connected one to one. For example, one catalog server 3 may be connected to plural terminals 2. In one network 4, the number of the catalog servers 2, which is not limited to two, may be one or more. The terminals 2 and the catalog servers 3 may be wirelessly connected or wired.

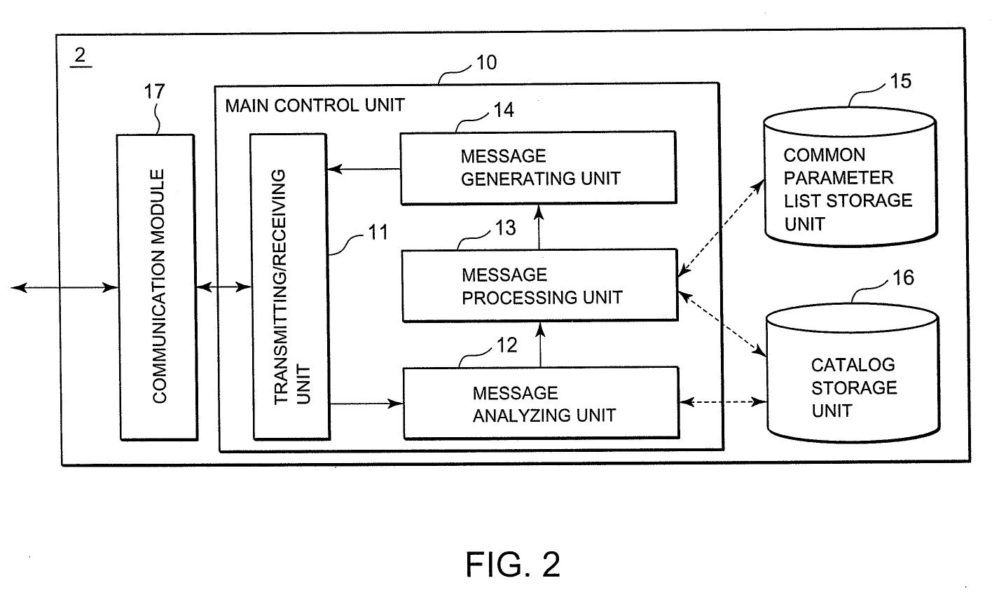

FIG. 2 is a block diagram showing the configuration of the terminal disclosed in FIG. 1. The terminal 2 may be a very simple resource which may be inexpensive. The terminal 2 includes, as hardware, a sensor (not shown in FIG.2 ) that detects information to be exchanged by the terminal 2 but the sensor itself is not directly concerned with the present invention. In addition, the illustrated terminal 2 is not limited to a sensor terminal and, therefore, a description is omitted in connection with the hardware of the terminal 2.

The terminal 2 includes a main control unit 10, a common parameter list storage unit 15, a catalog storage unit 16, and a communication module 17. The main control unit 10, which is a main portion of a computer configured with CPU, RAM, OS, and the like, can execute operations of a transmitting/receiving unit 11, a message analyzing unit 12, a message processing unit 13, and a message generating unit 14, all of which are implemented by computer programs run on the computer. In other words, the main control unit 10 is operated in accordance with the computer programs stored in a computer-readable medium (not shown) acting as a computer program product which includes software instructions.

The transmitting/receiving unit 11 controls the communication module 17 to transmit and receive messages through the network 4. The transmitting/receiving unit 11 receives messages directed to its own terminal that arrive from the network 4, transfers them to the message analyzing unit 12, and transmits messages generated in the message generating unit 14 to the network 4. The communication module 17 may carry out wireless communication or wired communication.

The message analyzing unit 12 syntactically analyzes a message received by transmitting/receiving unit 11 to identify a message type and acquire each of communication parameters. When a catalog identifier described later is included in the received message, a communication parameter is acquired which corresponds to the catalog identifier from the catalog storage unit 16. Next, the acquired message type and communication parameter are notified from the message analyzing unit 12 to the message processing unit 13.

The message processing unit 13 performs a process for signaling on the basis of the message type and communication parameter acquired by message analyzing unit 12. As a result of the signaling process, when a response message or new message must be transmitted, the message processing unit 13 notifies the message type of a transmission message and the communication parameter to the message generating unit 14. In this case, the communication parameter is replaced by a corresponding catalog identifier when the communication parameter can be cataloged or listed as a catalog identifier as described later by referring to the common parameter list storage unit 15 and the catalog storage unit 16. Thus, the corresponding catalog identifier is notified from the message processing unit 13 to the message generating unit 14.

The message generating unit 14 generates a message according to the message type and the communication parameter notified from the message processing unit 13, and notifies the generated message to the transmitting/receiving unit 11 for transmission.

The common parameter list storage unit 15 stores a list of communication parameters handled as common parameters. The catalog storage unit 16 stores catalog identifiers and communication parameters corresponding to the catalog identifiers. The content of information stored by the common parameter list storage unit 15 and the catalog storage unit 16 will be described later.

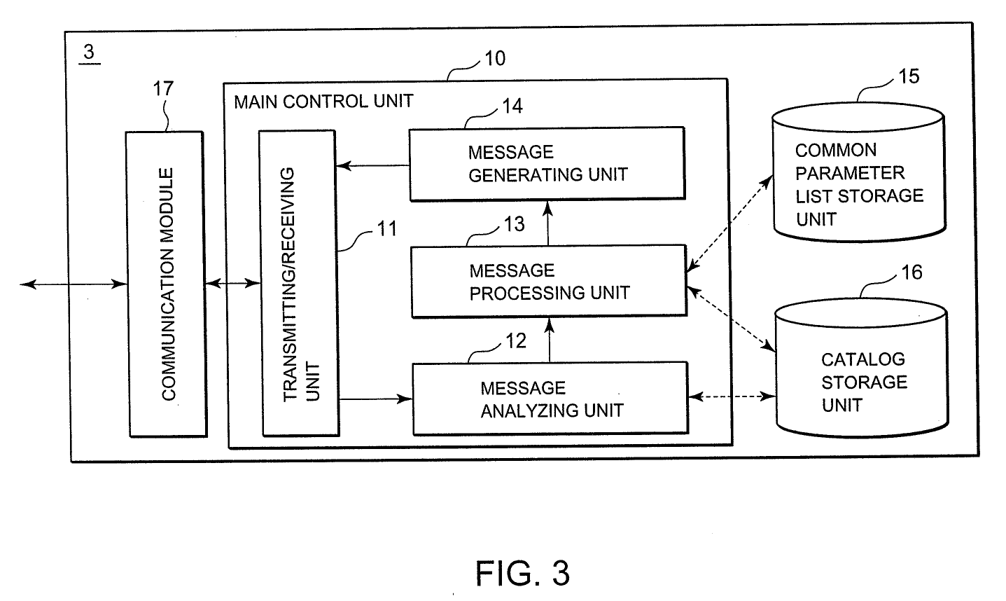

FIG. 3 is a block diagram showing the configuration of the catalog server disclosed in FIG. 1. The catalog server 3, unlike the terminal 2, may have an advanced one with rich resources. However, the internal construction of the catalog server 3 is the same as that of terminal 2, except that the catalog server 3 is different in the performance of individual parts from the terminal 2. Therefore, identical reference numerals are assigned to identical portions, and descriptions of them are omitted.

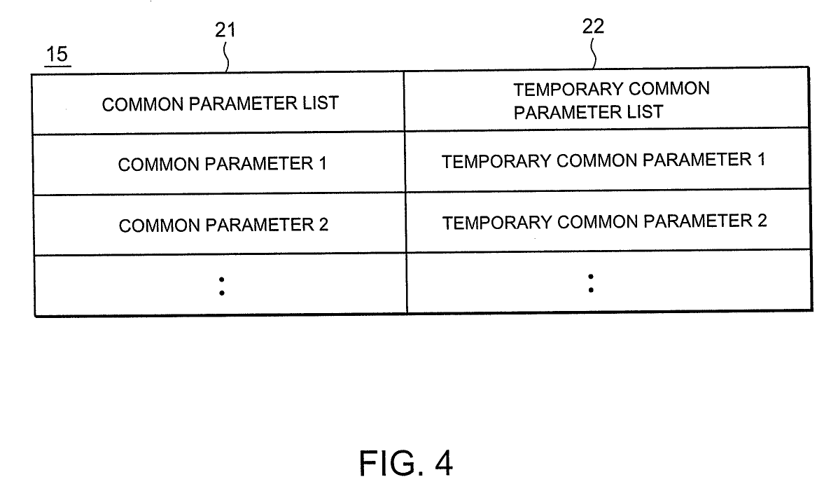

FIG. 4 is a conceptual diagram showing the structure of data stored in a common parameter list storage unit 15 within the terminal 2 and the catalog server 3 disclosed in FIGS. 2 and 3. The common parameter list storage unit 15 stores a common parameter list 21 composed of a list of communication parameters that can always use the same values in each of different terminals, and a temporary common parameter list 22 composed of a list of communication parameters that can use the same values only during a limited period such as a specific session or dialog.

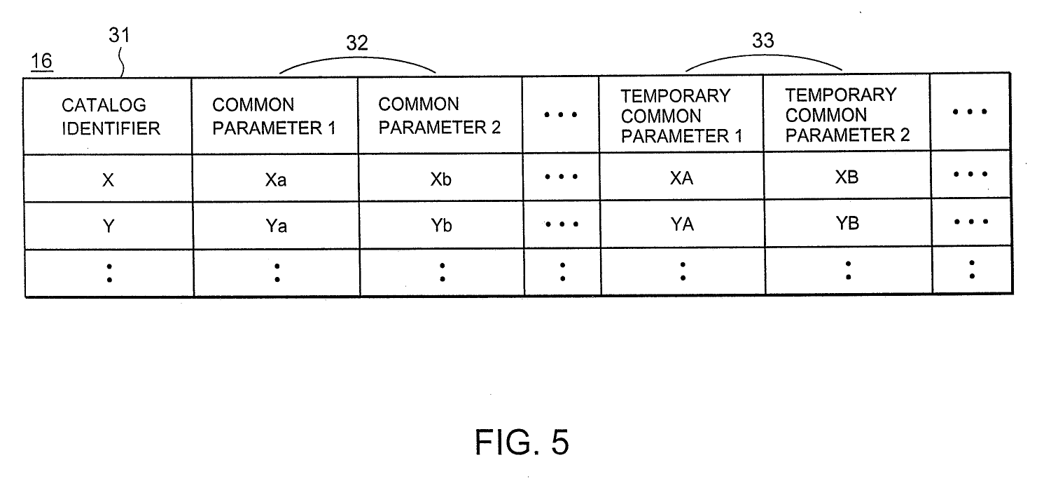

FIG. 5 is a conceptual diagram showing the structure of data stored in a catalog storage unit 16 within the terminal 2 and the catalog server 3 disclosed in FIGS. 2 and 3. The catalog storage unit 16 stores catalog identifiers 31, and common parameters 32 and temporary common parameters 33 that are used in catalogs indicated by the catalog identifiers 31. The contents and operation of them will be described later. As shown in FIG. 5, each of the catalog identifiers X, Y, and etc. is used in common to a plurality of the common parameters 1, 2, . . . indicated by 32 and the temporary common parameters XA, XB . . . indicated by 33. In addition, each catalog identifier is represented by a short sequence of characters as compared with the respective common parameters. In other words, each catalog identifier represents a group of the common parameters and the temporary common parameters like a catalog or a list and has a very small amount of information in comparison with the common parameters and the temporary common parameters.

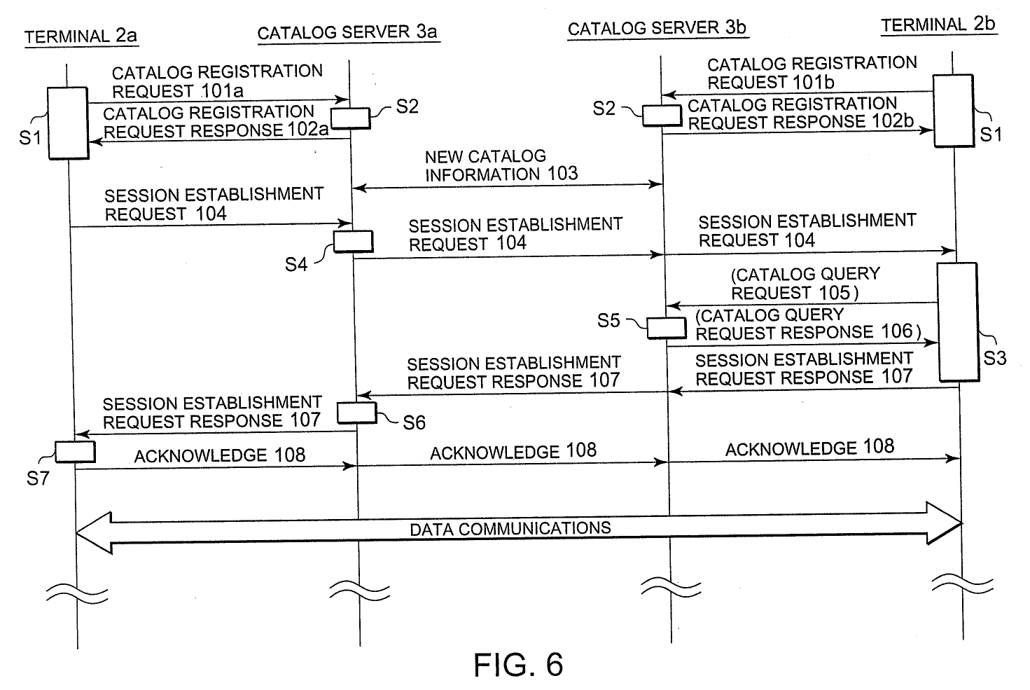

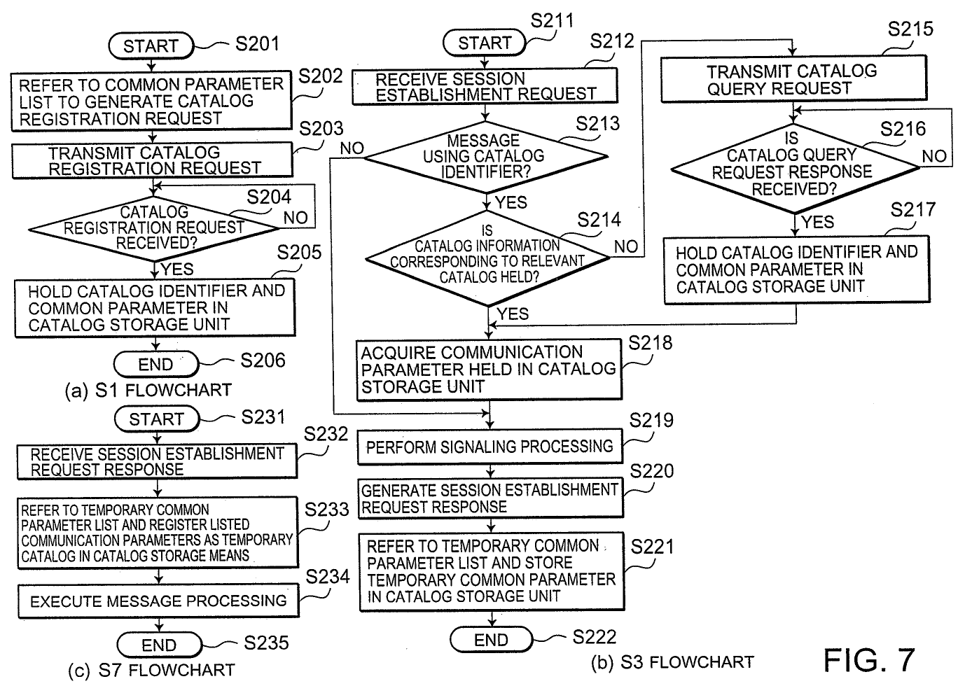

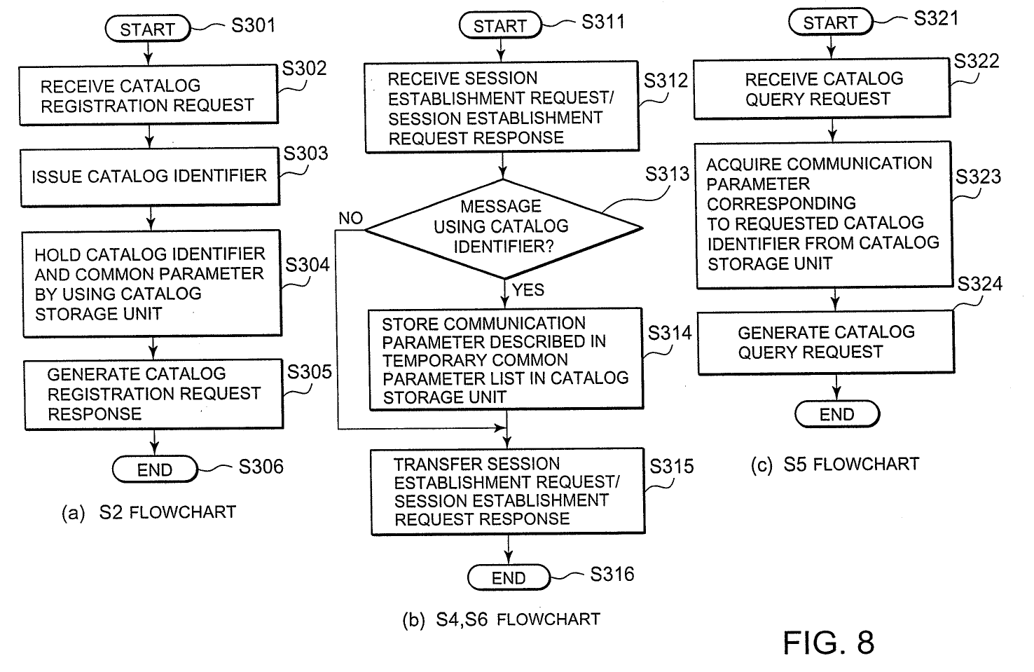

FIG. 6 is a sequence diagram showing a communication procedure of the data communication system 1 disclosed in FIG. 1. FIG. 7 is a flowchart showing the content of processing in the terminal 2 disclosed in FIG. 2. FIG. 8 is a flowchart showing the content of processing in the catalog server 3 disclosed in FIG. 3.

In FIG. 6, when the terminal 2a has been connected to the catalog server 3a, it transmits a catalog registration request 101a for registering a common parameter to the catalog server 3a. On receiving it, the catalog server 3a returns a catalog registration request response 102a to the terminal 2a. Likewise, between the terminal 2b and the catalog server 3b, the terminal 2b transmits a catalog registration request 101b to the catalog server 3b. On receiving it, the catalog server 3b returns a catalog registration request response 102b to terminal 2b.

FIG. 7(a) shows processing related to the catalog registration request 101a and the catalog registration request response 102a within the terminal 2 that is shown as S1 in FIG. 6. When the processing has been started (S201), the message generating unit 14 refers to the common parameter list 21 held in the common parameter list storage unit 15 to create a catalog registration request 101a (S202), and the transmitting/receiving unit 11 transmits the catalog registration request 101a to the catalog server 3 (S203).

The transmitting/receiving unit 11 waits for the catalog registration request response 102a from the catalog server 3 (S204), and when it receives the catalog registration request response 102a, the message analyzing unit 12 extracts the catalog identifier 31 and common parameter 32 described in the catalog registration request response 102a. The message processing unit 13 stores the extracted catalog identifier 31 and common parameter 32 in the catalog storage unit 16 (S205), and the processing is finished (S206).

FIG. 8(a) shows processing related to the catalog registration request 101a and the catalog registration request response 102a within the catalog server 3 that is shown as S2 in FIG. 6. When the processing has been started (S301), the transmitting/receiving unit 11 receives the catalog registration request 101a (S302), and the message processing unit 13 issues a catalog identifier 31 that is unique in the system (S303), and stores the issued catalog identifier 31 and a common parameter 32 described in the catalog registration request 101a extracted by the message analyzing unit 12 in the catalog storage unit 16 (S304).

The message generating unit 14 generates a catalog registration request response 102a including the catalog identifier 31 and the common parameter 32, and commands the transmitting/receiving unit 11 to transmit it (S305), and the processing terminates (S306).

When the catalog server 3 newly issues the catalog identifier 31 in S303, the catalog server 3 notifies, to another catalog server 3, new catalog information 103 including the catalog identifier 31, a common parameter 32 corresponding to it, and a temporary common parameter 33. Thereby, information can be synchronized among catalog servers, and the common parameter 32 included in the catalog registration request 101 a by the terminal 2a is registered in all catalog servers 3. Thus, catalog registration is completed. In subsequent exchange of messages, all terminals 2 can replace the common parameter 32 by the catalog identifier 31 during communication.

The terminal 2a requests the terminal 2b to establish a session and, as a result, a session is established between the terminals 2a and 2b and establishment of the session enables data communication. The following description would be directed to the above-mentioned processing. In FIG. 6, the terminal 2a issues a session establishment request 104 to the terminal 2b. The session establishment request 104 transmitted from the terminal 2a is received in the catalog server 3a.

FIG. 8(b) shows processing related to the session establishment request 104 within the catalog server 3a that is shown as S4 in FIG. 6. When the processing is started (S311), the transmitting/receiving unit 11 receives the session establishment request 104 (S312), and the message analyzing unit 12 determines whether or not the session establishment request 104 is a message using the catalog identifier 31 (S313). If it is a message using the catalog identifier 31, the message analyzing unit 12 stores a temporary common parameter 33 included in a temporary common parameter list 22 of the common parameter list storage unit 15 into the catalog storage unit 16 (S314), and proceeds to S315. The temporary common parameter 33 is stored as a temporary common parameter 33 corresponding to the catalog identifier 31.

In S313, if the session establishment request 104 is not a message using the catalog identifier, the processing proceeds to S315. The message generating unit 14 transfers the received session establishment request 104 without modifications to the terminal 2b via the transmitting/receiving unit 11 (S315), and the processing terminates (S316). The transferred session establishment request 104 is sent to the terminal 2b without special processing in the catalog server 3b.

FIG. 7(b) shows processing related to the session establishment request 104 within the terminal 2b that is shown as S3 in FIG. 6. When the processing is started (S211), the transmitting/receiving unit 11 receives the session establishment request 104 (S212), and the message analyzing unit 12 determines whether or not the session establishment request 104 is a message using the catalog identifier 31 (S213). If it is not a message using the catalog identifier 31, the processing proceeds to S210 described later.

In S213, if the session establishment request 104 is a message using the catalog identifier 31, the message analyzing unit 12 determines whether or not information (hereinafter referred to as catalog information) of a common parameter 32 and a temporary common parameter 33 that correspond to the catalog identifier 31 exists in the catalog storage unit 16 (S214). If catalog information corresponding to the catalog identifier 31 exists, the processing proceeds to S218 described later.

In S214, if catalog information corresponding to the catalog identifier 31 does not exist, the message generating unit 14 generates a catalog query request 105, and transmits it to the catalog server 3b via the transmitting/receiving unit 11 (S215). The transmitting/receiving unit 11 waits for a catalog query request response 106 from the catalog server 3b (S216). If a catalog query request response 106 arrives, the terminal 2b stores catalog information described in the catalog query request response 106 extracted by the message analyzing unit 12 in the catalog storage unit 16 (S217), and proceeds to S218.

In S218, the message processing unit 13 acquires a communication parameter included in catalog information corresponding to the catalog identifier 31 from the catalog storage unit 16. It performs signaling processing by the acquired communication parameter (S219). In S219, if the request is not a message using the catalog identifier 31 in S213 described previously, since no communication parameter needs to be acquired from the catalog storage unit 16, the signaling processing is directly performed.

The message generating unit 14 generates a session establishment request response 107 and transmits it to the terminal 2a via the transmitting/receiving unit 11 (S220), from the generated session establishment request response 107, the message analyzing unit 12 stores a temporary common parameter 33 included in a temporary common parameter list 22 of the common parameter list storage unit 15 into the catalog storage unit 16 as the temporary common parameter 33 corresponding to the catalog identifier 31 (S221), and the processing terminates (S221).

FIG. 8(c) shows processing related to the catalog query request 105 within the catalog server 3b that is shown as S5 in FIG. 6. When the processing is started (S321), the transmitting/receiving unit 11 receives a catalog inquiry request 105 (S322), the message analyzing unit 12 extracts a catalog identifier 31 from the catalog query request 105, and the message processing unit 13 acquires catalog information corresponding to the extracted catalog identifier 31 from the catalog storage unit 16 (S323). The message generating unit 14 creates a catalog query request response 106 including the acquired catalog information, and transmits it to the terminal 2b via the transmitting/receiving unit 11 (S324), and the processing terminates (S325).

When the terminal 2b completes the signaling processing for the session establishment request 104, it returns a session establishment request response 107 to the terminal 2a. The session establishment request response 107 is sent to the catalog server 3a via the catalog server 3b. The catalog server 3a performs the same processing as the processing shown as (b) of FIG. 8 for the session establishment request response 107, acquires a temporary common parameter 33, and registers it in the catalog storage unit 16. Here, processing for registering the temporary common parameter 33 is performed for the communication parameter newly added by the terminal 2b. Although the processing is shown as S6 in FIG. 6, the content of the processing is omitted because it is the same as (b) of FIG. 8. Upon termination of the processing, the catalog server 3a directly transfers the session establishment request response 107 to the terminal 2a.

FIG. 7(c) shows processing related to the session establishment request response 107 in the terminal 2a that is shown as S7 in FIG. 6. When the processing is started (S231), the transmitting/receiving unit 11 receives the session establishment request response 107 (S232). The message analyzing unit 12 extracts a communication parameter from the session establishment request response 107. If the extracted communication parameter is listed in the temporary common parameter list 22 of the common parameter list storage unit 15, the extracted communication parameter is stored as a temporary common parameter 33 in the catalog storage unit 16 by the message processing unit 13 (S233).

The terminal 2a performs normal signaling processing for the session establishment request response 107, returns an acknowledge message 108 to the terminal 2b (S234), and terminates the processing (S235).

The acknowledge message 108 is sent directly to the terminal 2b via the catalog server 3a and the catalog server 3b. This completes session establishment between the terminals 2a and 2b. As a result of the completion of session establishment, the temporary common parameter is registered as catalog information in the catalog server 3a and the catalog server 3b. In subsequent message exchange within an identical session or dialog, in addition to the common parameter, the temporary common parameter can also be replaced by a catalog identifier for communication.

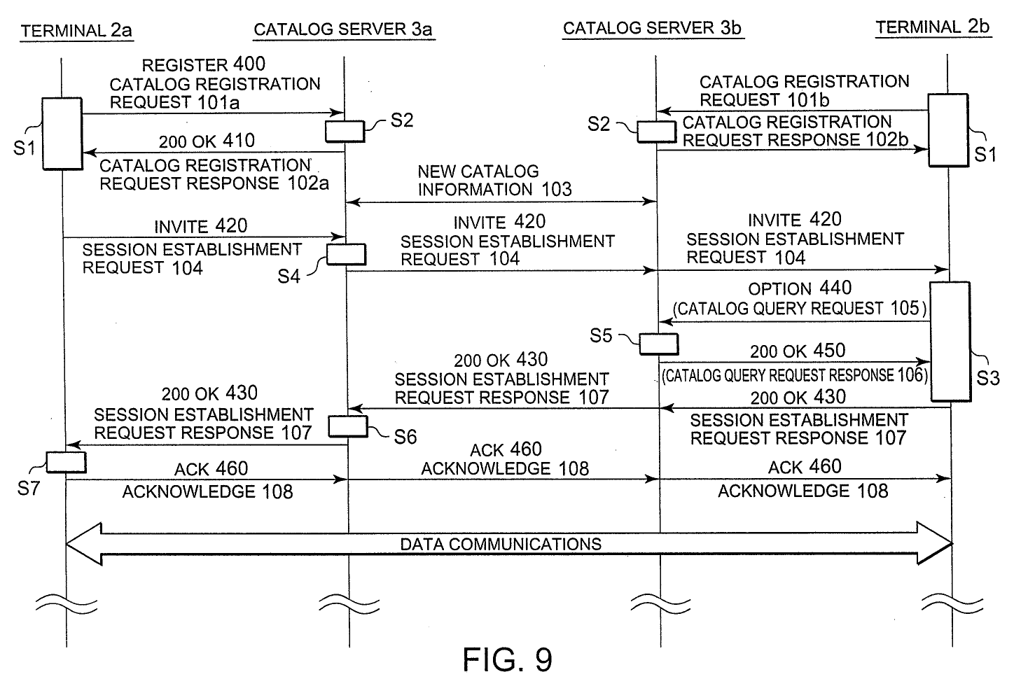

FIG. 9 is a sequence diagram showing an example of performing the communication procedure of FIG. 6 in accordance with a concrete protocol. Here, a description is made of the case where the present invention is applied to SIP (Session Initiation Protocol). SIP is one of (RFC3261) signaling protocols standardized in IETF (Internet Engineering Task Force), and there is VoIP (Voice over Internet Protocol) as one of primary applications. System configuration and a processing procedure are the same as those having been described so far. The catalog server 3 may be installed in the same device as a proxy server in SIP.

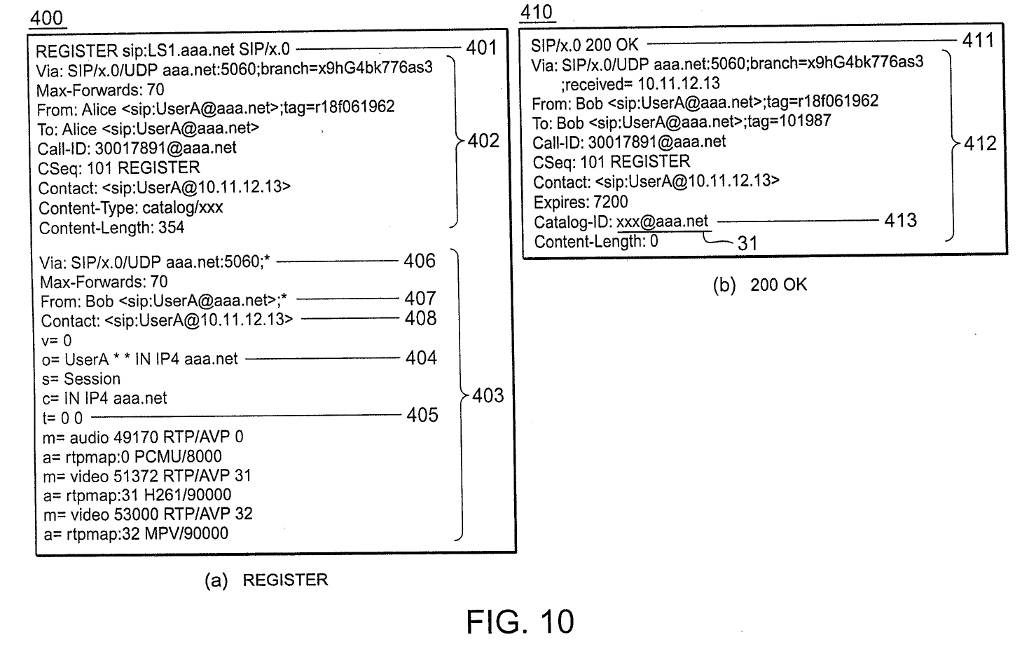

FIG. 10 is an example of a catalog registration request 101 a transmitted to the catalog server 3a by the terminal 2a in FIG. 9 and a catalog registration request response 102a returned to the terminal 2a by the catalog server 3a. The terminal 2a transmits a REGISTER message 400 shown in FIG. 10(a) to the catalog server 3a as a catalog registration request 101a.

Like a normal request in SIP, the REGISTER message 400 is formulated in a manner such that a body 403 is arranged after a request 401 and a header 402 with one empty line left between the header 402 and the body 403. The request 401 consists of “REGISTER” indicating the type (method) of the request, “sip:LSI.aaa.net” indicating the catalog server 3a as the destination of the request, and “SIP/x.0” indicating the version of SIP. Like a normal request in SIP, the header 402 includes lines, such as Via, Max-Forwards, From, To, Call-ID, CSeq, Contact, Content-Type, and Content-Length. A detailed description of the header is omitted because the header is known to those skilled in the art.

The body 403 includes common parameters 32 to be registered as a catalog by the terminal 2a. Information described here is information used in common in the header, and a part of session information described in an SIP body portion using SDP (Session Description Protocol). Whether or not each parameter described here is handled as a common parameter 32 is determined by referring to the common parameter list 21 stored in the common parameter list storage unit 15 of the catalog server 3a.

Plural communication parameters are included in one line, and when part of communication parameters included in a relevant line is not a common parameter, it is replaced by an abbreviation such as “*” to indicate that it is a non-common parameter portion. In an example of FIG. 10(a), “*” indicating a non-common parameter portion is included in o=line 404 being a type indicating information for identifying a session. For communication parameters replaced by an abbreviation, their value is described each time message transmission is performed.

Although Via line 406, From line 407, and Contact line 408 used in the header also include “*” indicating a non-common parameter portion, since they are included in the common parameter list 21, they are registered as common parameters 32 here.

Since t=line 405 being a type indicating the start and end times of a session is not included in the common parameter list 21, it is not registered as a common parameter 32. Since v=line, s=line, c=line, m=line, and a=line indicating other parameters are included in the common parameter list 21, they are registered as common parameters 32.

On receiving a REGISTER message, the catalog server 3a issues a catalog identifier 31 for common parameters 32 described in the body 403 in the message processing unit 13, and performs processing shown as (a) of FIG. 8 (S2 of FIGS. 6 and 9). Here, “xxx@aaa.net” is issued as the catalog identifier 31. Next, the catalog server 3a returns a 200 OK response (hereinafter simply referred to as OK response) 410 shown in FIG. 10(b), as a catalog registration request response 102a, to the terminal 2a. The OK response 410, like a normal response in SIP, is organized in a format of status 411 and header 412. Here, it is to be noted that any body is not included.

The status 411 consists of “SIP/x.0” indicating the version of SIP and “200 OK” indicating a status. The header 412 includes lines Via, From, To, Call-ID, CSeq, Contact, Expires, Content-Length (a detailed description of them is omitted because they are known to those skilled in the art) like a normal request in SIP, as well as a catalog-ID line 413 indicating an issued catalog identifier 31.

On receiving an OK response 410, the terminal 2a stores a catalog identifier 31 and catalog information corresponding to it in the catalog storage unit 16, by processing shown as (a) of FIG. 7 (S1 of FIGS. 6 and 9). This completes catalog registration.

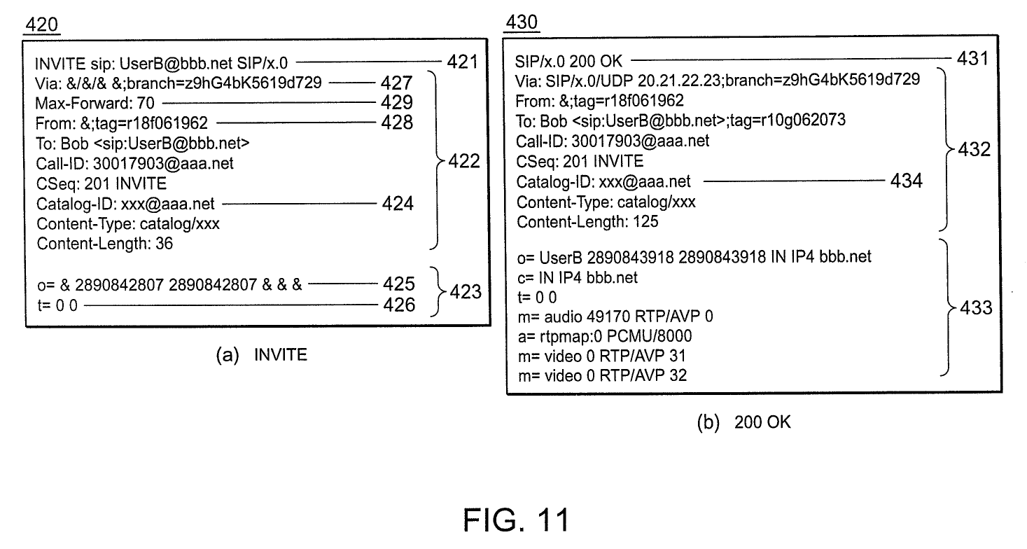

FIG. 11 shows an example that, in FIG. 9, the terminal 2a transmits a session establishment request 104 to the terminal 2b, and the terminal 2b returns a session establishment request response 107 to the terminal 2a. The terminal 2a transmits an INVITE message 420 shown in FIG. 11(a) as the session establishment request 104 to the terminal 2b.

Like a normal request in SIP, the INVITE message 420 is formulated in a format in which a request 421 and a header 422 are included together with a body 423 with one empty line left between the header 422 and the body 423. The request 421 consists of “INVITE” indicating the type (method) of the request, “sip:UserB@bbb.net” indicating URI as the destination of the request, and “SIP/x.0” indicating the version of SIP. The header 422 includes a Catalog-ID line 424 indicating the above-described catalog identifier 31, in addition to the same lines as the header 402 of the REGISTER message 400.

When the terminal 2a generates a message, the message generating unit 14 refers to the common parameter list 21 held in the common parameter list storage unit 15 to omit the common parameters 32 throughout the line or to replace them by an abbreviation such as “&” for description of them in the body 423.

Particularly, for a common parameter 32 including a non-common parameter portion replaced by an abbreviation such as “*”, a numeric value or the like is described in a portion corresponding to “*,” and other portions are replaced by an abbreviation such as “&.”In an example of FIG. 11(a), two of “*” indicating a non-common parameter portion are included in o=line 425 of the body 423 and the line is registered as a common parameter 32, here, two numeric values corresponding to * and abbreviations “&” indicating other portions are described. Since t=line 426 is not included in the common parameter list 21, it is described as it is. In the body 423, since other parameters (v=line, s=line, c=line, m=line, and a=line) all are included in the common parameter list 21, and non-common parameter portions are not present, the entire line is omitted.

Also in the header 422, since Via line 406 and From line 407 are already registered as common parameters 32 including “*” indicating a non-common parameter portion, here, for Via line 427 and From line 428, portions corresponding to * of common parameters 32 are described and other portions are described by the abbreviation “&.” Since Contact line 408 is already registered wholly as a common parameter 32, it is omitted in the header 422. By the way, Max-Forward line 429 is described as it is (this is because although Max-Forwards line 409 is registered in a common parameter 32, Max-Forward line 429 does not correspond to the common parameter 32).

On receiving the INVITE message 420, the catalog server 3a extracts a temporary common parameter 33 included in the INVITE message 420 by processing shown in FIG. 8(b) (S4 of FIGS. 6 and 9), stores it in the catalog storage unit 16, and transfers the received INVITE message 420 to the terminal 2b without performing special processing for the message 420 itself. Examples of the temporary common parameter 33 include tag within From line 428 of the header 422, and a communication parameter whose value is used in plural messages within an identical dialog such as Call-ID line.

On receiving the INVITE message 420 via the catalog server 3b, the terminal 2b performs processing shown in FIG. 7(b) (S3 of FIGS. 6 and 9), and returns an OK response 430 shown in FIG. 11(b) to the terminal 2a as a session establishment request response 107. The OK response 430, like the OK response 410 shown in FIG. 10(b), is formulated in a manner such that a status 431 and a header 432 are included and a body 433 follows the header 432 with an empty line left. The header includes a Catalog-ID line 434 like the OK response 410. The body 433 is session information described by SDP indicating communication conditions established between the terminals 2a and 2b. Since these are known to those skilled in the art, a detailed description of them is omitted.

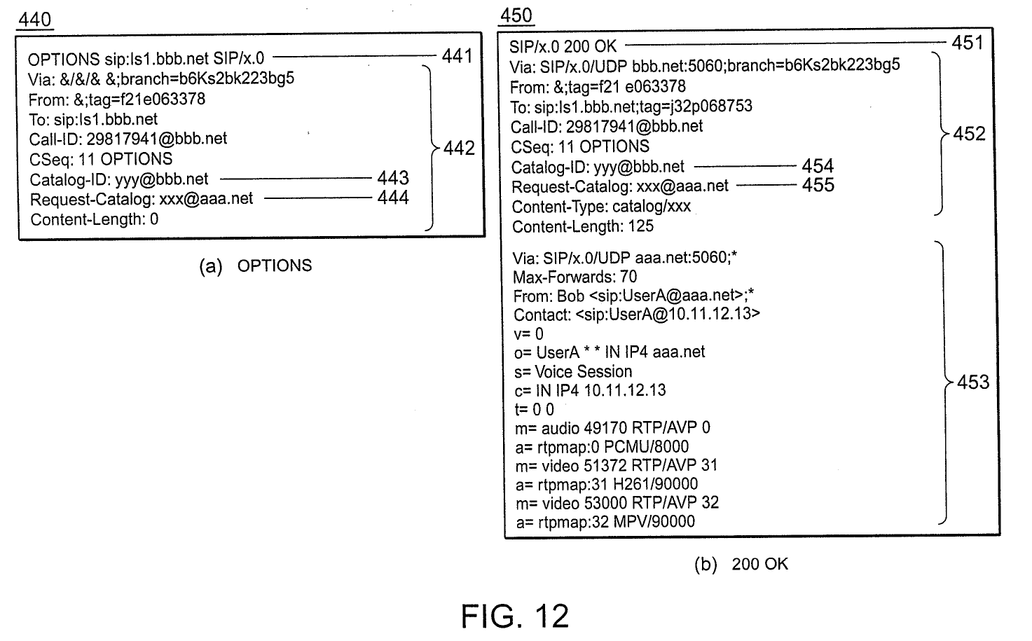

FIG. 12 shows an example of a catalog query request 105 transmitted to the catalog server 3b by the terminal 2b in FIG. 9, and a catalog query request response 106 replied to the terminal 2b by the catalog server 3b. The terminal 2b, as a catalog query request 105, transmits an OPTIONS message 440 shown in FIG. 12(a) to the catalog server 3b.

Although the OPTIONS message 440 consists of a request and a header 442 like a normal request in SIP, no body is present in the illustrated message 440. The request 441 consists of “OPTIONS” indicating the type (the method) of the request, “sip:ls1@bbb.net” indicating URI as the address of the request, and “SIP/x.0” indicating the version of SIP. The header 442 consists of lines similar to those of the header 422 of the INVITE message 420. The header 442 includes a Request-Catalog-ID row 444 including a catalog identifier 31 targeted for catalog information query.

The terminal 2b previously transmits the same REGISTER command as shown in FIG. 10(a) to the catalog server 3b to register its own catalog information. Therefore, in the header 442 of the OPTIONS message 440, a Catalog-ID line 443 including a catalog identifier corresponding to catalog information registered by the terminal 2b is included, and like the INVITE message 420 described previously, part of the header 442 is omitted based on the registered catalog information.

On receiving the OPTIONS message 440, the catalog server 3b performs processing shown in FIG. 8(c) (S5 of FIGS. 5 and 9) and returns an OK response 450 shown in FIG. 12(b) as a catalog query request response 106. The OK response 450 is formulated in a manner such that a status 451 and a header 452 like the OK response shown in FIG. 10(b) are included and a body 453 follows the header 452 with one empty line left between the header 452 and the body 453. The header includes Catalog-ID line 454 and Request-Catalog-ID line 455 like the OK response 410. In the body 453, catalog information corresponding to a catalog identifier 31 included in a Request-Catalog-ID line 444 of the OPTIONS message 440 is described in the same format as that of the body 403 of the REGISTER message 400.

The terminal 2b transmits the OPTIONS message 440 to the catalog server 3b to obtain catalog information, thereby acquiring catalog information corresponding to the catalog identifier 31 included in the Request-Catalog-ID line 455 and storing it in the catalog storage unit 16. As a result, since information about the common parameter 32 of the terminal 2a can be obtained, for the INVITE message with a significant reduction in data amount, signaling processing can be performed like normal INVITE messages by analyzing communication parameters.

On receiving the OK response 430 (session establishment request response 107), the terminal 2a performs processing shown in FIG. 7(c) (S7 of FIGS. 6 and 9), and transmits an ACK request 460 to the terminal 2b as the acknowledge message 108. Since the ACK request 460, and S7 and subsequent processing are known to those skilled in the art, a detailed description of them is omitted.

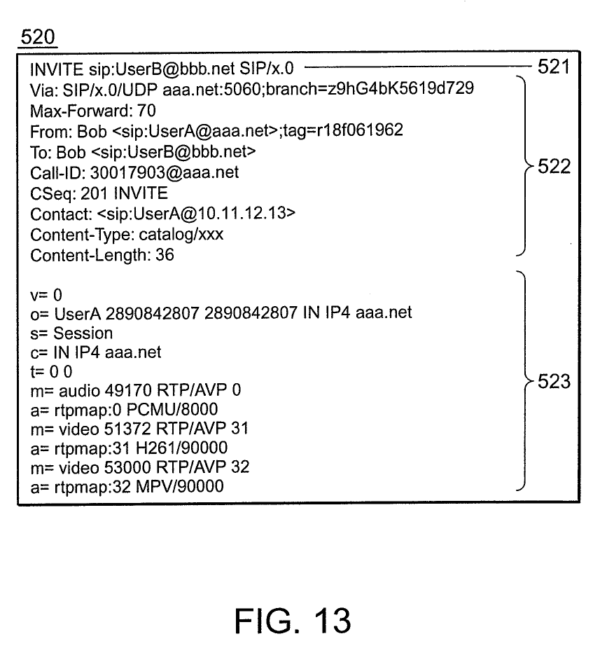

FIG. 13 shows an example of a conventional INVITE message 520 issued by a terminal in a conventional communication system different from the embodiment according to the present invention. A conventional INVITE message 520 is organized in a format in which a request 521 and a header 522 are included and a body follows the header 522 with one empty line left between the header 522 and the body 523.

It will be understood that, when the conventional INVITE message 520 and the INVITE message 420 of this embodiment shown in FIG. 11(a) are compared, a conventional INVITE message 520 has at least seven lines (11 lines in FIG. 13) in parameter description in the body 523, while the body 423 of this embodiment has two lines in parameter description, so that the amount of description per line is less. Although the header 422 of this embodiment has a Catalog-ID line 424 not found in the conventional header 522, the Via line 427, part of the From line 428, and the entire Contact line are omitted. As a result, it is quite obvious that the amount of data of the INVITE message 420 of this embodiment is significantly reduced, in comparison with the conventional INVITE message.

By this embodiment, by applying the common parameter 32 registered as catalog information, parameters used in common in a header and a body can be replaced by catalog identifiers of small data size for communications. Therefore, also in other than the INVITE message, if session establishment processing shown in FIGS. 6 to 12 is completed, in all messages transmitted and received by terminals, data amounts can be reduced by the same method as this.

Since processing during message transmission/reception by terminals can be performed by simple replacement processing, complicated data compression/decompression is not required. Therefore, an increase in processing amounts in the terminals as a result of applying this embodiment is trivial.

As has been described above, by this embodiment, the data amount of the message can be reduced without a substantial increase of throughput in terminals. Therefore, since even inexpensive terminals with small resources can easily implement this embodiment, it can be said that such terminals have a construction suitable for reducing costs.

SIP shown in and after FIG. 9 is merely an example of one of protocols generally often used. The present invention can be used also for other protocols. Although the present invention is suitable for use in inexpensive terminals with resources reduced, the type of terminals is not limited to sensor terminals and the like in a sensor network. For example, the present invention can also be used in terminals that perform voice communications by VoIP, which is one of SIP applications, such as the so-called IP phone.

Although the present invention has been described with specific embodiments shown in the drawings, it goes without saying that the present invention is not limited to the embodiment shown in the drawings, and can be adopted in any configurations having been known so far that have the effects of the present invention.

The present invention is usable in networks configured by terminals that perform data communications. There are no special limitations on protocol types and the types of terminals and data.

What is claimed is:

1. A data communication system in which plural terminals communicates with each other through a network,
wherein each of the terminals comprises:
a first transmitting/receiving unit that communicates with other terminals through the network;
a first catalog storage unit that stores common parameters associated with catalog identifiers; and
a first message generating unit that replaces the common parameters included in communication data by the catalog identifiers for transmission to the other terminals.

2. The data communication system according to claim 1,
wherein each of the terminals comprises:
a first message analyzing unit that determines whether or not a catalog identifier is included in communication data received from other terminals; and
a first message processing unit that, if the catalog identifier is included in the received communication data, replaces the catalog identifier by the common parameter.

3. The data communication system according to claim 2,
wherein the network includes a catalog server that can communicate with the terminals,
wherein each of the terminals transmits, to the catalog server, a common parameter list which specifies a list of communication parameters handled as the common parameters by the first message generating unit, and
wherein the catalog server includes:
a second transmitting/receiving unit that communicates with other terminals and catalog server through the network;
a second message processing unit that issues the catalog identifier for the common parameter list;
a second catalog storage unit that stores common parameters described in the common parameter list in association with the catalog identifiers; and
a second message generating unit that returns the catalog identifiers to the terminals.

4. The data communication system according to claim 3,
wherein, in each of the terminals, the first message analyzing unit analyzes whether or not a catalog identifier is included in the communication data received from the other terminals, and whether or not the catalog identifier is included in the first catalog storage unit, and
wherein, if the catalog identifier is not included in the first catalog storage unit, the first message processing unit inquires of the catalog server as to the common parameter corresponding to the catalog identifier.

5. The data communication system according to claim 4,
wherein, in the catalog server, in response to the inquiry about the common parameter from the terminals, the second message processing unit retrieves the common parameter corresponding to the catalog identifier from the second catalog storage unit, and
wherein the second message generating unit transmits the retrieved common parameter to the terminals.

6. The data communication system according to claim 1,
wherein the common parameter includes a temporary common parameter usable only in a specific period.

7. A terminal mutually communicable with other terminals through a network, comprising:
a transmitting/receiving unit that communicates with other terminals through the network;
a catalog storage unit that stores common parameters associated with catalog identifiers; and
a message generating unit that replaces the common parameters included in communication data by the catalog identifiers for transmission to the other terminals.

8. The terminal according to claim 7, comprising:
a message analyzing unit that analyzes whether or not a catalog identifier is included in communication data received from other terminals; and
a message processing unit that, if the catalog identifier is included in the received communication data, replaces the catalog identifier by the common parameter.

9. The terminal according to claim 8,
wherein the message generating unit transmits, to the catalog server connected to the network, a common parameter list which specifies a list of communication parameters handled as the common parameters by the message generating unit, and
wherein the catalog storage unit stores a catalog identifier received from the catalog server in association with the common parameter list.

10. The terminal according to claim 9,
wherein the message analyzing unit analyzes whether or not a catalog identifier is included in the communication data received from the other terminals, and whether or not the catalog identifier is included in the catalog storage unit, and
wherein, if the catalog identifier is not included in the catalog storage unit, the message processing unit inquires of the catalog server as to the common parameter corresponding to the catalog identifier.

11. The terminal according to claim 10,
wherein the catalog storage unit stores the common parameter corresponding to the catalog identifier returned from the catalog server in response to the inquiry in association with the catalog identifier.

12. The terminal according to claim 7,
wherein the common parameter includes a temporary common parameter usable only in a specific period.

13. A catalog server used in a data communication system in which plural terminals and one or plural catalog servers communicate with each other through a network, comprising;
a transmitting/receiving unit that communicates with other terminals through the network, and receives a common parameter list which specifies a list of communication parameters handled as common parameters by the terminals;
a message processing unit that issues a catalog identifier for the common parameter list;
a catalog storage unit that stores common parameters described in the common parameter list in association with the catalog identifiers; and
a message generating unit that returns the catalog identifier to the terminals.

14. The catalog server according to claim 13,
wherein, in response to the inquiry about the common parameter from the terminals, the message processing unit retrieves the common parameter corresponding to the catalog identifier from the catalog storage unit, and
wherein the message generating unit transmits the retrieved common parameter to the terminals.

15. A data communications method in a data communication system in which plural terminals each including a first catalog storage unit communicate with each other through a network, comprising:
in each terminal,
generating communication data to be transmitted to other terminals;
retrieving a common parameter associated with a catalog identifier from the first catalog retrieving unit;
replacing the common parameter included in the communication data by the catalog identifier; and
transmitting the replaced communication data to the other terminals.

16. The data communications method according to claim 15, comprising:
in each terminal,
analyzing whether or not a catalog identifier is included in the communication data received in the receiving process; and
further replacing the catalog identifier by the common parameter, if the catalog identifier is included in the received communication data.

17. The data communication method according to claim 16,
wherein the network includes a catalog server that can communicate with the terminals and has a second catalog storage unit;
the data communication method including, in each terminal,
transmitting, to the catalog server, a common parameter list which specifies a list of communication parameters handled as common parameters; and
in the catalog server,
receiving the common parameter list;
issuing the catalog identifier for the common parameter list;
storing a common parameter described in the common parameter list in the second catalog storage unit in association with the catalog identifier; and
returning the catalog identifier to the other terminals.

18. A communication program product that instructs a computer included in a terminal having a first catalog storage unit that can communicate mutually with other terminals through a network to execute the functions of:
generating communication data to be transmitted to other terminals;
retrieving a common parameter associated with a catalog identifier from the first catalog storage unit;
replacing the common parameter included in the communication data by the catalog identifier; and
transmitting the replaced communication data to the other terminals.

19. The communication program product according to claim 18, instructing the computer included in the terminal to execute the functions of:
receiving communication data from other terminals;
analyzing whether communication data received in the receiving step includes a catalog identifier; and
if the catalog identifier is included in the received communication data, replacing the catalog identifier by the common parameter.

20. A communication program product that instructs a computer included in a catalog server including a second catalog storage unit that can communicate mutually with plural terminals and one or plural catalog servers through a network to execute the functions of:
receiving the common parameter list from the terminals;
issuing the catalog identifier for the common parameter list;
storing a common parameter described in the common parameter list in the second catalog storage unit in association with the catalog identifier; and
replying the catalog identifier to the terminals.
